(19) United States
(12) Patent Application Publication
(10) Pub. No.: US 2010/0095139 A1
(43) Pub. Date: Apr. 15, 2010

(54) DOCKING STATION

(75) Inventors: David Victor Murphy, Queensland (AU); Nathan Thomas Westgarth, Queensland (AU); Wayne Gregory Uroda, Queensland (AU)

Correspondence Address: Grabba International Pty Ltd, P.O. Box 56, Coopers Plains, 4108, AU

(73) Assignee: Grabba International Pty Ltd., Coppers Plains, Queenlands (AU)

(21) Appl. No.: 12/450,886

(22) PCT Filed: Apr. 24, 2008
(86) PCT No.: PCT/AU2008/000582

§ 371 Date: Oct. 16, 2009

(30) Foreign Application Priority Data
Apr. 26, 2007 (AU) 2007902192

(51) Int. Cl. G06F 1/26; H02J 7/00

(52) U.S. Cl. 713/300; 320/127

(57) ABSTRACT

The present invention relates to a docking station that is operable as a host. The docking station is suitable for docking a portable device that is operable as a slave. The portable device may be, for example, a personal digital assistant (PDA) or a mobile phone. The docking station includes determination means for determining an operational voltage of the docked portable device. An adjustable power supply outputs a supply voltage to the docked portable device in accordance with the determined operational voltage. Typically, the power supply includes control means (e.g. microcontroller) for controlling the supply voltage outputted from the adjustable power supply. The present invention also relates to a method for outputting the supply voltage from the host docking station to the docked slave portable device.

### TECHNICAL FIELD

The present invention generally relates to a docking station for docking a portable device including, for example, a personal digital assistant (PDA) or a mobile phone.

The present invention also generally relates to an electrical device which is operable as a host and is suitable for connecting to a portable device which, in turn, is operable as a slave.

### BACKGROUND

The reference to any prior art in this specification is not, and should not be taken as an acknowledgement or any form of suggestion that the prior art forms part of the common general knowledge.

A Universal Serial Bus (USB) is a computer bus which can support peripheral devices including printers, digital cameras, keyboards and mice, and storage devices. In some applications, the USB platform supports Plug-and-Play installation and hot plugging. Typically, one device connected to the USB bus operates as a host device whereas the other devices operate as subservient slave devices which respond to commands from the host device.

WO 2004/034266 discloses a USB docking station which is operable as a USB host and can be used to dock a mobile phone which, in turn, is operable as a slave. In this manner, the mobile phone and docking station are interconnected by a USB bus containing data signal lines and a power supply line (VBUS). The applicant has found that in practice, many computing and communications devices (e.g. mobile telephones) do not comply with the USB voltage standards and accordingly the docking arrangement of WO 2004/034266 may work for some USB client devices, and not others.

Furthermore, WO 2004/034266 discloses that a host personal computer (PC) can be connected to the USB bus, where-after the docking station relinquishes its host status. However, directly coupling the PC, the docking arrangement and the mobile phone to the USB bus is somewhat undesirable as damage of any one of these devices may occur as a result of contention on the USB bus when establishing communications between the devices.

### SUMMARY OF THE INVENTION

According to one aspect of the present invention, there is provided a docking station operable as a host and for docking a portable device operable as a slave, the docking station including:
determination means for determining an operational voltage of the docked portable device; and
an adjustable power supply for outputting a supply voltage to the docked portable device in accordance with the determined operational voltage.

Preferably, the power supply includes control means for controlling the supply voltage outputted from the adjustable power supply. The docking station may further include connection means for connecting a host device to the control means wherein, upon connection, the control means relinquishes the host operation of the docking station. The host device may be a personal computer.

The adjustable power supply may be controlled to set the supply voltage to either a voltage line derived from an internal battery of the docking station or an operating voltage of said host device.

The docking station may further include a connector assembly with which the portable device is connected when docked. The docking station may further include a switch which is electrically coupled to the control means, and between the connection means and the connector assembly, so that the control means can switch the switch to electrically isolate or connect the connection means and the connector assembly.

The docking station may further include a connection interface for connecting one or more peripheral devices to the control means. The connection interface may include a universal serial bus (USB) interface.

The adjustable power supply may include a battery, a plurality of integrated circuits (ICs) each coupled to the battery and for supplying respective IC output voltages, and a switching arrangement which can be switched by the control means so that a selected one of said IC output voltages forms said supply voltage outputted from the adjustable power supply. The adjustable power supply may further include a power supply line provided from a host connector and the switching arrangement may be further configured to be switched so that the power supply line forms said supply voltage outputted from the adjustable power supply.

The docking station may further include a battery charging circuit for charging the battery using the power supply line.

The portable device may be one or more of a personal digital assistant (PDA), a mobile phone or any other like wireless communications device.

The determination means and the adjustable power supply may include a common processor.

According to another aspect of the present invention, there is provided an electrical device operable as a host and for connecting to a portable device operable as a slave, the electrical device including:
determination means for determining an operational voltage of the connected portable device; and
an adjustable power supply for outputting a supply voltage to the connected portable device in accordance with the determined operational voltage.

According to another aspect of the present invention, there is provided a method for outputting a supply voltage from a host docking station to a slave portable device docked to the docking station, the method including the step of:
determining an operational voltage of the docked portable device; and
outputting the supply voltage to the portable device in accordance with the determined operational voltage.

The step of outputting may involve selecting the supply voltage from either: a voltage line derived from an internal battery of the docking station or an external power supply.

The method may further include the steps of:
relinquishing the host operation of the docking station; and
connecting another host device to the portable device via said docking station.

The step of connecting may involve switching a switch so that the other host device and the portable device go from a state of electrical isolation to a state of electrical connection.

Subsequent to the step of connecting, the method may further include the step of charging an internal battery of the portable device using a power source of the other host.

Prior to the step of determining, the method may include the step of setting the supply voltage to a minimum voltage level to minimise initial drainage of an internal battery of the docking station to the portable device.

Subsequent to the step of determining, the method may further involve the step of disabling the charging of an internal battery of the portable device.

The method may further include the step of establishing communications between one or more peripheral devices connected to the docking station and the docked portable device.

According to another aspect of the present invention, there is provided a method for outputting a supply voltage from a host to a slave portable device connected to the host, the method including the step of:
determining an operational voltage of the slave portable device; and
outputting the supply voltage to the slave portable device in accordance with the determined operational voltage.

According to a further aspect of the present invention, there is provided a storage media, such as a magnetic or optical disk or solid state memory, containing computer readable instructions for execution by one or more processors to thereby perform any one or more of the preceding methods.

According to a further aspect of the present invention, there is provided one or more processors which are loaded with computer readable instructions to perform any one or more of the preceding methods.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic diagram showing a docking station for docking a personal digital assistant (PDA) according to an embodiment of the present invention;

FIG. 2 is a schematic diagram of a Battery Management and Power Supply Module of the docking station of FIG. 1;

FIG. 3 is a schematic diagram of an adjustable VBUS control module 14 of the docking station of FIG. 1;

FIG. 4 is a schematic diagram of a USB switch module of the docking station of FIG. 1;

FIG. 5 is a flowchart of a Docking Station Operational Method performed by the docking station of FIG. 1;

FIG. 6 is a flowchart of a Docking Station Initialisation Method performed by the docking station of FIG. 1;

FIG. 7 is a flowchart of an Initialisation Method performed using a low voltage tolerant PDA;

FIG. 8 is a flowchart of an Initialisation Method performed using a low voltage intolerant PDA; and

FIG. 9 is a flowchart of a PDA Initialisation Method performed by a PDA docked to the docking station of FIG. 1.

### DETAILED DESCRIPTION OF PREFERRED EMBODIMENTS

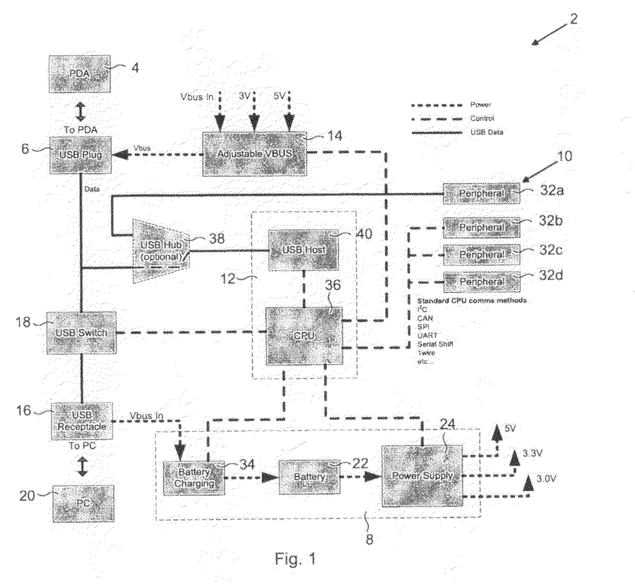

According to an embodiment of the present invention, there is provided a portable docking station 2 operable as a host and for docking a slave personal digital assistant (PDA) 4 as shown in FIG. 1. The docking station 2 includes a cradle (not shown) into which the PDA 4 can be slid into and electrically coupled to a Universal Serial Bus (USB) plug 6 of the docking station 2.

The docking station 2 further includes a USB Receptacle 16 to facilitate engagement of the docking station 2 to a host personal computer (PC) 20. A USB Switch Module 18 is provided for electrically connecting the PDA 4 to the PC 20, to enable the establishment of communications between both of these devices 4,20. The docking station 2 is operable as a host device when the PDA 4 is connected to the CPU/USB Host Module 12 and relinquishes its host status when the host PC 20 is connected to the PDA 4.

The docking station 2 further includes a Battery Management/Power Supply Module 8, a Peripheral Module 10 and an Adjustable VBUS Control Module 14. A detailed description of the docking station 2 is provided below.

### Hardware

The circuit elements and modules of the docking station 2 are interconnected by electrical conductors which carry power, control and USB data signals as generally shown in FIG. 1.

Battery Management/Power Supply Module 8

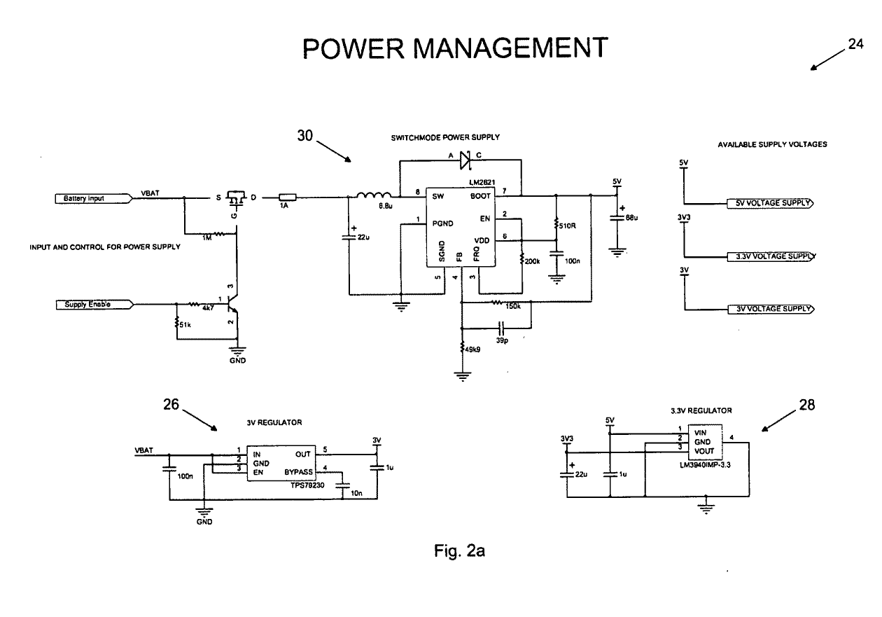

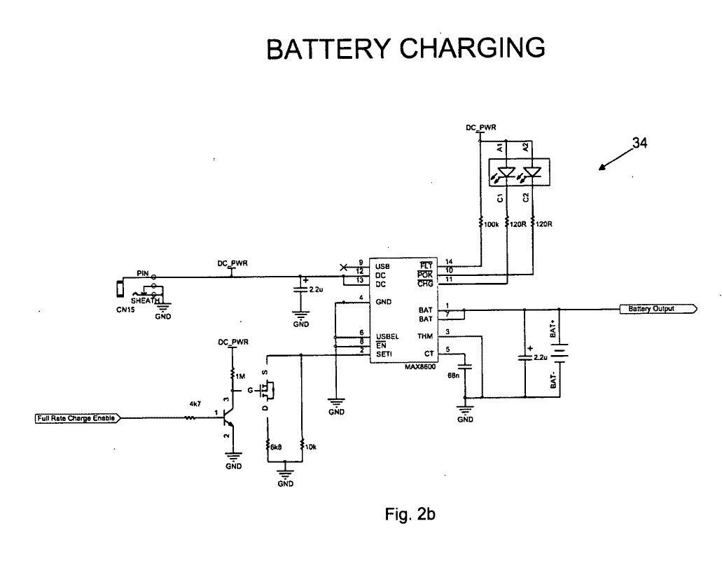

The Battery Management/Power Supply Module 8 includes a battery 22 which, in turn, supplies power to power supply circuitry 24. The battery 22 is a protected Lithium-Ion cell. The power supply circuitry 24 provides voltage levels (3.0V, 5.0V) to be adjustably switched by the Adjustable VBUS Control Module 14. Referring briefly to FIG. 2a, the power supply circuitry 24 provides a 5.0V switched mode power supply 30 with a 3.3V linear regulator 28, and also a 3.0V linear regulator 26 connected directly to the battery 22 as its source. This provides the minimum required voltages of 5.0V and 3.0V to facilitate adjustable control of the Adjustable VBUS Control Module 14, as well as a supply voltage of 3.3V to supply power to any peripherals 32 coupled to the Peripheral Module 10.

The battery 22 is able to be charged by either an external DC supply, or by the bus (VBUS) voltage from the PC 20 (i.e. host) connected to the USB receptacle 16. The trickle charge current supplied from the Battery Charging circuitry 34 is adjustable by the CPU 36 so that higher charge currents can be used when an external DC supply is connected to the receptacle 16 (rather than the bus voltage from the PC 20). The CPU 36 defaults to set the lower charge current so that maximum current capabilities of the PC 20 are not exceeded. A schematic diagram of the Battery Charging Circuit 34 is shown in FIG. 2b.

Peripheral Module 10

Returning to FIG. 1, the peripheral module 10 includes a number of connectors by which peripheral devices 32 can be connected to the CPU 36. Exemplary connectivity interfaces include I²C, UART, SPI, CAN, 1 wire, serial shift out, or proprietary communication interfaces of the connected peripherals 32.

The CPU 36 can simultaneously connect with a number of peripherals 32a-d. Example peripherals 32 include barcode scan engines and imaging devices, magnetic stripe card readers, contact and non-contact smartcard readers, and proximity card readers. Example peripherals 32 can also include external ports such as RS232 and/or USB ports to allow any peripheral 32 using these standard connectivity protocols to communicate with the CPU 36.

The peripheral module 10 may further include a USB hub 38 for interfacing a USB peripheral 32a to a USB host/slave controller device 40 and, in turn, the CPU 36. The USB hub 38 further enables connection between the USB host/slave controller device 40 and USB plug 6, and the USB host/slave controller device 40 and the USB peripheral 32a. The USB hub 38 is configured to enable the CPU 36 to communicate to the USB peripheral 32a whilst maintaining the ability to communicate with the PDA 4 connected to the USB plug 6.

CPU/USB Host Module 12

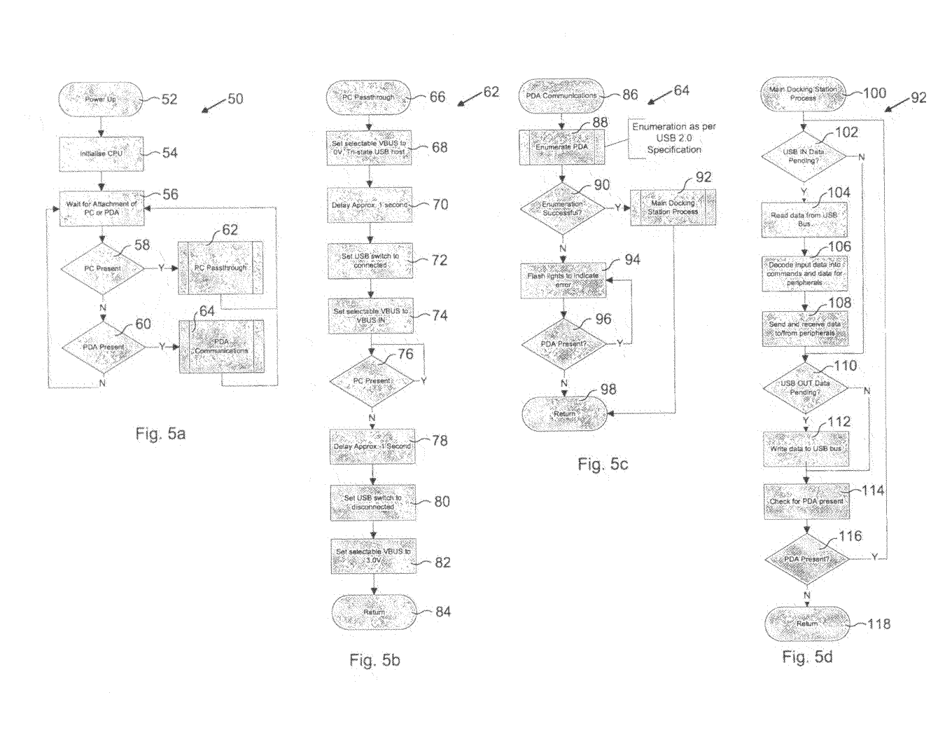

The CPU 36 is a microcontroller (or microprocessor) that facilitates communication between the peripherals 32 and the PDA 4 connected to the USB plug 6. The CPU 36 is a low power MSP430 processor which can be put to sleep to maximise the life of the battery 22. The CPU 36 includes memory in which a docking station software product containing machine-readable instructions is stored. In use, the CPU 36 executes these machine-readable instructions to perform the docking station operation method of FIG. 5 which is described in detail below.

The USB host/slave controller 40 is a Maxim MAX3421E integrated circuit (IC) which facilitates USB host communications of the docking station 2 with the PDA 4 connected to the USB plug 6, and USB slave communications of the docking station 2 with the PC 20 connected to the USB receptacle 16.

The CPU 36 can configure the USB host/slave controller 40 to switch to a slave operational mode of the docking station 2, thereby allowing the CPU 36 to communicate with the PC 20 (i.e. host). Alternatively, the CPU 36 can configure the USB host/slave controller 40 to switch to a master operational mode of the docking station 2, thereby allowing the CPU 36 to communicate with the PDA 4 (i.e. slave). The CPU 36 can also configure the USB host/slave controller 40 to tri-state its USB bus drivers in order to avoid bus contention when the PDA 4 is communicating directly to the PC 20.

Adjustable VBUS Control Module 14

Different types of PDAs 4, and other like wireless communications devices, can be connected to the USB plug 4. The Applicant has found that, in practice, not all PDAs 4 strictly adhere to the USB standard. Accordingly, some PDAs 4 require 5.0V supplied on their VBUS power supply line in order to communicate with the CPU 36 (as specified by the USB standard), while others will communicate with either 3.0V or 5.0V supplied on their VBUS power supply line.

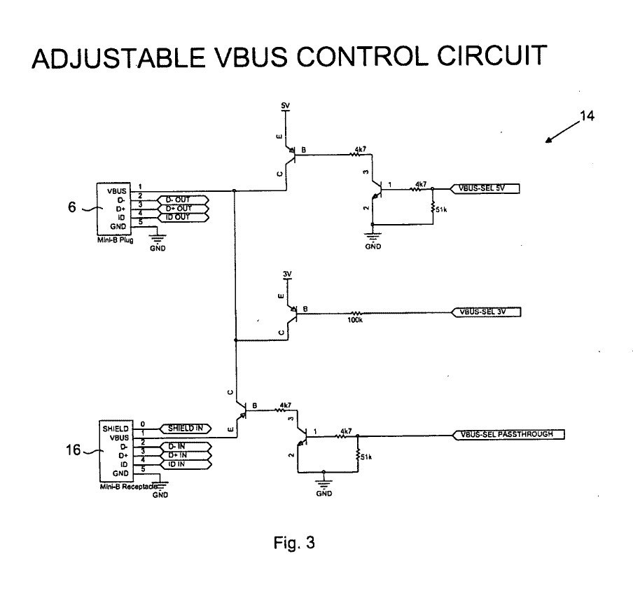

When the PC 20 is not connected to the USB receptacle 16, the adjustable VBUS control module 14 is controlled or adjusted to supply either 5.0V or 3.0V to the connected PDA 4 to allow communication. Alternatively, the adjustable VBUS control module 14 is configured to enable the VBUS voltage from the PC 20 connected to the USB receptacle 16 to be supplied to the PDA 4, instead of from the Battery 22. A schematic diagram of the adjustable VBUS control module 14 is shown in FIG. 3.

By default, the CPU 36 controls the adjustable VBUS control module 14 so that 3.0V is supplied to the VBUS of the connected PDA 4. The CPU 36 is configured to detect the connection of the PDA 4 or the PC 20 to the docking station 2, and to respectively supply power from the power supply circuitry 24 (e.g. 5.0V) or the VBUS signal from the PC 20 to the VBUS power supply line of the PDA 4 (see FIG. 3). In this manner, the life of the battery 22 can be conserved by alternatively supplying power to the VBUS power supply line of the PDA 4 from the PC 20 whenever possible. Additionally, the PDA 4 will charge its own battery whenever the VBUS power supply line of the PDA 4 is supplied by the VBUS signal from the PC 20.

USB Receptacle 16

The USB receptacle 16 enables the PC 20 connected to this port to communicate with the PDA 4 connected to the USB plug 6. The USB receptacle 16 can also connect to an external DC supply (not shown) to supply power to the battery 22 via the battery charging circuit 34. The CPU 36 is configured to detect the presence of either the PC 20 or the external DC supply connected to the USB receptacle 26, and distinguishes between the two using the connected USB bus.

Elaborating further, the CPU 36 can differentiate between the PC 20 and the external DC supply by monitoring the standard USB “D+ data line”. If the PC 20 is detected, the CPU 36 controls the USB switch module 18 and the adjustable VBUS control module 14 to enable communications and power connection between the PC 20 and the PDA 4. If the CPU 36 detects that the external DC supply is coupled to the USB Receptacle 16, the CPU 36 enables higher charge current through the Battery Charging circuitry 34, and full rate charging of the battery 22 is performed. In this event, the CPU 36 also controls the adjustable VBUS control module 14 to enable the DC supply to charge the PDA 4. Alternatively, if the PC 20 is detected, the CPU 36 enables lower charge current through the Battery Charging circuitry 34, and a lesser rate of charging of the battery 22 is performed. In this event, charging of the PDA 4 is also performed as previously described.

USB Plug 6

The USB plug 6 is located within the docking cradle and connects with the PDA 4 which, in turn, functions as a USB slave. The CPU 36 is configured to detect the presence of the PDA 4 connected to the USB plug 6 using the standard USB “D+ data line” coupled to a logic gate circuit (not shown). The CPU 26 can determine the standard operational voltage of the PDA 4 using established communications from the PDA 4. As previously described, the VBUS supply voltage supplied to the connected PDA 4 can be varied by CPU 36 between 0 v, 3.0 v, 5.0 v, and VBUS IN from the USB receptacle 16, using Adjustable VBUS Control Module 14. Accordingly, the CPU 36 can selectively control the Adjustable VBUS Control Module 14 to supply an appropriate power supply voltage to the PDA 4, depending upon the power requirements of the PDA 4 and/or the power source connected to the USB receptacle 16.

USB Switch Module 18

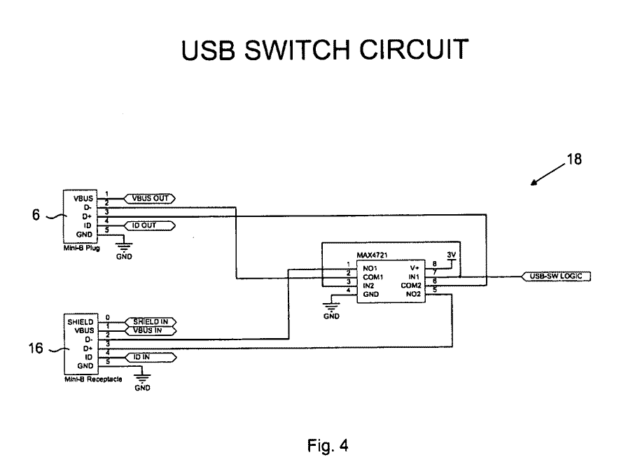

The USB switch module 18 provides electrical isolation between the USB receptacle 16 and the other USB interfaces (including USB plug 6, USB Host/Slave controller 40 and peripheral 32a) during establishment of communications between any of the devices 4,20,32 and the CPU 36. The electrical isolation between the USB receptacle and the USB plug 6, for example, removes the possibility of bus contention between PC 20 and the PDA 4 while PDA 4 is connected to CPU 36, which could potentially lead to the damage of one of these devices. The USB switch module 18 allows the docking station 2 to defer the connection between the PC 20 and the PDA 4, until after the CPU 36 has completed any critical communications with the PDA 4. As shown in FIG. 4, the USB switch module 18 includes a Maxim MAX4721 integrated circuit (IC) which is a type of electrical switch.

### Docking Station Software

Docking Station Operational Method 50

As previously mentioned, the docking station software product stored in the memory of the CPU 36 can be executed by CPU 36 to perform the docking station operational method 50 shown in FIG. 5.

Referring to FIG. 5a, the docking station 2 is initially activated at step 52.

At step 54, the CPU 36 of the docking station 2 is initialised.

At step 56, the CPU 36 enters a low power sleep state until the PDA 4 is connected to the USB plug 6 or the PC 20 is connected to the USB receptacle 16, upon which the CPU 36 wakes up and resumes processing at step 58.

If the CPU 36 determines that the PC 20 is connected at step 58, the CPU 36 performs the PC connection method 62 of FIG. 5b. Alternatively, if the CPU 36 determines that the PDA 4 is connected at step 60, the CPU 36 performs the PDA connection method 64 of FIG. 5c.

PC Connection Method 62

The PC connection method 62 is shown in FIG. 5b.

Initially, at step 66, the method 62 begins.

At step 68, the CPU 36 disables each switch of the Adjustable VBUS Control Module 14 shown in FIG. 3. The CPU 36 also configures the USB host/slave controller device 40 to tri-state its USB lines.

At step 70, the VBUS power supply line is permitted to stabilise for a time period (e.g. 1 second).

At step 72, the CPU 36 sets the USB Switch Module 18 so that the PC 20 is directly connected to the PDA 4.

At step 74, the CPU 36 sets the Adjustable VBUS Control Module 14 so that the VBUS power supply line from the PC 20 is connected to the corresponding VBUS power supply line of the USB plug 6.

At step 76, the CPU 36 verifies that the PC 20 is still connected. In the event that the CPU 36 determines that the PC has been disconnected at step 76, the method 62 is delayed by a time period (e.g. 1 second) at step 78.

At step 80, the CPU 36 disables the USB Switch Module 18 so that the PC 20 and PDA 4 are electrically isolated.

At step 82, the CPU 36 sets the Adjustable VBUS Control Module 14 so that a 3.0V power supply line is connected to the VBUS power supply line of the USB plug 6. The 3.0V supply is less than the rated 5.0V supply line of the PDA 4 to ensure that, in the event of PDA connection, the battery 22 is not drained by the PDA 4.

At step 84, the method 62 returns to the Docking Station Operational Method 50.

PDA Connection Method 64

The PDA connection method 64 is shown in FIG. 5c.

Initially, at step 86, the method 64 begins.

At step 88, the docking station 2 enumerates the PDA 4 in accordance with the standard USB 2.0 specification. In this manner, the host CPU 36 establishes communications and is provided with data relating to the newly connected slave PDA 4.

At step 90, the CPU 36 determines whether the enumeration process of step 88 was successful. In the event that the enumeration process was successful, the method 64 proceeds to the main docking station process 92 described in detail below with reference to FIG. 5d. Alternatively, if the enumeration process was unsuccessful, the method 64 proceeds to step 94.

At step 94, the CPU 36 controls lights of the docking station 2 to flash and thereby visually indicate that an enumeration error has occurred.

At step 96, the CPU 36 determines whether the PDA 4 is still connected. If the PDA 4 is connected, the method returns to step 94. Alternatively, if the PDA 4 is no longer connected to the USB plug 6, the method 64 proceeds to step 98 and, in turn, returns to the Docking Station Operational Method 50.

Main Docking Station Process 92

The Main docking station process 92 is shown in FIG. 5d.

Initially, at step 100 and upon verification of successful enumeration at step 90 of FIG. 5c, the method 92 begins.

At step 102, the CPU 36 determines whether there is data on the USB bus to be read from the PDA 4. If there is no data to be read, the process 92 proceeds to step 110. Alternatively, the process 92 proceeds to step 104.

At step 104, the CPU 36 reads data from the connected PDA 4 via the USB bus.

At step 106, the CPU 36 decodes the read data into commands and data relating to the peripherals 32.

At step 108, the CPU 36 communicates with the peripherals 32 in accordance with the decoded data.

At step 110, the CPU 36 determines whether there is data to be sent to the PDA 4 via the USB bus. If there is no data to be sent, the process 92 proceeds to step 114. Alternatively, the process proceeds to step 112.

At step 112, the CPU 36 writes data to be sent to the PDA 4 to the USB bus.

At steps 114 and 116, the CPU 36 determines whether the PDA 4 is still connected to the USB plug 6. If the PDA 4 is connected, the process returns to step 102. Alternatively, at step 118, the process returns to the PDA connection method 64.

### Communications Initialisation Method

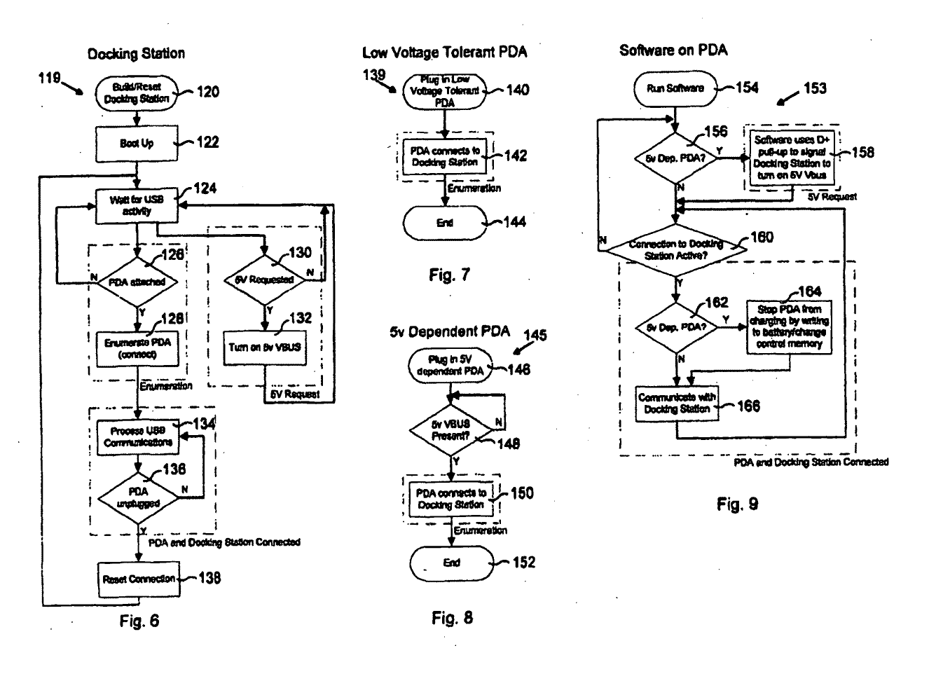

The flowcharts of FIGS. 6 to 9 demonstrate how the docking station 2, either a Low Voltage Tolerant PDA 4 or a 5 v Dependent PDA 4, and a PDA software product loaded on the PDA 4 work together to establish communications between the docking station 2 and the PDA 4.

As previously mentioned, the possible PDA types which can be docked with the docking station 2 fall into two broad categories: (1) those which are tolerant of low voltage on the VBUS power supply line (less than 5.0V and typically 3.0V, for example); and (2) those which are low voltage intolerant PDAs and cannot be used with a low supply voltage (e.g. 3.0V).

Upon detection of a docked low voltage tolerant PDA 4 (operable down to 3.0V) by the CPU 36, the CPU 36 controls the Adjustable VBUS Control Module 14 to supply 3.0V to the VBUS power supply line so that the PDA 4 cannot charge itself from the docking station battery 22. In this manner the life of the battery 22 is conserved.

However, if a low voltage intolerant PDA 4 operable at 5.0V is instead docked, the docking station 2 communicates with the PDA 4 to temporarily disable the battery charging functionality of the PDA 4. If this PDA battery charging operation is not disabled, the docking station's battery 22 will otherwise be undesirably drained (typically within 2-3 hours).

The initialisation procedure for low voltage tolerant and intolerant PDAs are described in detail below with reference to FIGS. 6 to 9. The ensuing description makes particular reference to FIG. 6 showing the docking station initialisation method 119 performed by a software product loaded on the docking station 2, and FIG. 9 showing a PDA initialisation method 154 performed by another software product loaded on the PDA 4.

Connection to Low Voltage Tolerant PDA

A docking station initialisation method 119 is shown in FIG. 6.

At step 120, the docking station 2 is activated subsequent to manufacture.

At step 122, the docking station 2 enters a “Boot Up” stage where initialisation of the device 2 occurs.

At step 124, the CPU 36 monitors the USB bus for USB activity and is in a very low power state. In practice, the docking station 2 can maintain this low power state so that the life of the battery 22 can exceed 6 months before requiring recharging.

At step 126, USB activity is detected when the PDA 4 is connected to the USB plug 6 (see corresponding step 140 of FIG. 7). The PDA 4 is low voltage tolerant, and recognises the docking station 2 which outputs a 3.0 v VBUS power supply line when in a standby mode.

At step 128, the CPU 36 enumerates the PDA 4 (see corresponding step 142 of FIG. 7).

At step 134, the CPU 36 begins processing USB communications from the PDA 4 (and the method 139 effectively terminates at step 144). The CPU 36 continues to process USB communications until the PDA 4 is disconnected from the USB plug 6 (or the PDA 4 is powered down) at step 136 and then the connection is reset at step 138.

After the connection is reset at step 138, the method 119 returns to step 124.

Connection to Low Voltage Intolerant (i.e. 5 v Dependent) PDA

The low voltage intolerant PDA 4 is loaded with a PDA software product which performs the PDA initialisation method 153 shown in FIG. 9.

At step 154, the low voltage intolerant PDA 4 executes the software product when the PDA 4 is connected at step 146 of FIG. 8.

If at step 156, the PDA 4 verifies that it is low voltage intolerant, the PDA 4 requests that the docking station 2 set the output VBUS power supply line from the Adjustable VBUS Control Module 14 to 5.0V at step 158. In turn and at step 130 of FIG. 6, the CPU 36 controls the Adjustable VBUS Control Module 14 to output 5.0V to the PDA at step 132. The CPU 36 then enumerates the PDA 4 as shown in corresponding steps 150 of FIG. 8, and 126 and 128 of FIG. 6.

At step 160, the PDA 4 determines whether it has an active connection with the docking station 2.

If at step 162, the PDA 4 is confirmed as being low voltage intolerant, the battery recharging function of the PDA 4 is disabled when the PDA software product writes appropriate data to the battery charge control memory of the PDA 4 at step 164.

At step 166, the PDA 4 communicates with the docking station 2 as also shown in the corresponding steps 134 and 136 of FIG. 6. The docking station 2 USB communications are processed; and the loop repeats back to step 160 until the PDA 4 is unplugged or powered down (or the PDA software product is terminated).

A person skilled in the art will appreciate that many embodiments and variations can be made without departing from the ambit of the present invention.

In the preferred embodiment, the docking station 2 was suitable for docking a PDA 4. In another embodiment, the docking station may be suitable for docking a mobile phone.

In the preferred embodiment, the USB receptacle 16 was suitable for connecting to a host PC 20. In another embodiment, the USB receptacle 16 may be suitable for connecting an alternative type of host device such as a palm pilot or laptop computer, for example.

In the preferred embodiment, the CPU 23 could simultaneously connect with four peripherals 32a-d. In other embodiments, further peripherals 32 may be interfaced to a larger CPU (with more communication ports), or through the use of multiplexers and de-multiplexers.

In the preferred embodiment, the CPU/USB Host Module 12 included a discrete Maxim MAX3421E integrated circuit (IC) to facilitate USB communications. Alternatively, a microcontroller with an embedded USB host and/or slave controller could be used in place of a discrete USB host/slave controller device 40 and a discrete CPU 36.

In the preferred embodiment, the docking station 2 included a determination means for determining an operational voltage of the PDA 4, with the determination means including the CPU 36 and associated circuitry for reading USB data from the connected PDA 4 relating to its rated operational voltage. In another embodiment, the determination means may instead include the CPU 36 and associated circuitry for monitoring (or measuring) the VBUS power supply line of the USB plug upon connection of the PDA 4, and thereby determine the operational voltage of the PDA 4.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A docking station operable as a Universal Serial Bus (USB) host device for docking a portable device operable as a slave, including:
processing circuitry for controlling operation of the docking station;
a power supply including a battery for supplying a voltage to the portable device;
a USB connector for connecting with the portable device, such that the processing circuitry is capable of communicating with the portable device, the processing circuitry being configured to determine a voltage tolerance of the portable device; and
an adjustable VBUS control module connected to the processing circuitry for supplying a voltage to the portable device, the processing circuitry being configured to adjust a voltage supplied to the portable device by the VBUS control module in response to the voltage tolerance.

2. A docking station as claimed in claim 1, in which the adjustable VBUS control module is configured to adjust the voltage supplied to the portable device such that the battery is inhibited from being drained by a charge current drawn by the portable device.

3. A docking station as claimed in claim 1, wherein the processing circuitry is configured to control the VBUS control module such that the voltage supplied to the portable device is a minimum voltage within the voltage tolerance of the portable device.

4. A docking station as claimed in claim 1, wherein the processing circuitry is configured to control the VBUS control module so that the USB connector can be connected with the portable device while an upper voltage within the voltage tolerance is supplied to the portable device, subsequent to which a lower voltage is supplied to the portable device.

5. A docking station as claimed in claim 1, in which the processing circuitry is configured to communicate with the portable device such that the portable device is inhibited from drawing a charge current from the battery.

6. A docking station as claimed in claim 1, further including a connection means for connecting a host device to the processing circuitry, which is configured to relinquish a host operation of the docking station when the host device is connected to the processing circuitry.

7. A docking station as claimed in claim 6, wherein the processing circuitry is configured to control the VBUS control module to set the supply voltage to either a voltage line derived from an internal battery of the docking station or to an operating voltage of said host device.

8. A docking station as claimed in claim 6, further including a switch which is electrically coupled to the processing circuitry, and between the connection means and the USB connector, so that the processing circuitry can operate the switch to electrically isolate or connect the connection means and the USB connector.

9. A docking station as claimed in claim 1, further including a peripheral module configured for connecting one or more peripheral devices to the processing circuitry.

10. A docking station as claimed in claim 1, wherein the power supply module has battery charging circuitry, the battery being re-chargeable and connected to the battery charging circuitry, and power supply circuitry connected to the battery and configured to supply respective output voltages to the VBUS control module, the VBUS control module being configured to select one of the output voltages for supply to the USB connector.

11. A method of establishing and maintaining a connection between a portable slave device and a docking station having a power supply with a battery, the method including the steps of:
detecting docking of the portable device;
determining, within the docking station, a voltage tolerance of the docked portable device; and
adjusting a supply voltage to the portable device in response to the voltage tolerance.

12. A method as claimed in claim 11, in which the step of adjusting the supply voltage includes the step of providing a supply voltage at a minimum level within the voltage tolerance such that the battery is inhibited from being drained by a charge current.

13. A method as claimed in claim 11, which includes the step of communicating with the portable device such that the portable device is inhibited from drawing a charge current from the battery.

14. A method as claimed in claim 11, in which an upper voltage within the voltage tolerance is provided while the steps of detecting docking and determining the voltage tolerance are carried out, subsequent to which a lower voltage within the voltage tolerance is provided.

15. A method as claimed in claim 11, which includes the step of
detecting the connection of a host device to the docking station; and
switching a power supply to the slave device from the docking station to the host device upon such detection.

16. A method as claimed in claim 11, wherein the step of adjusting the supply voltage incorporates the step of selecting the supply voltage from one of a voltage line derived from the battery and an external power supply.

17. A data processor which is configured for use by a docking station of claim 1, such that, in operation, the data processor is capable of carrying out the following steps:
detecting docking of the portable device;
determining, within the docking station, a voltage tolerance of the docked portable device; and
adjusting a supply voltage to the portable device in response to the voltage tolerance.
